(19) United States
(12) Patent Application Publication
(10) Pub. No.: US 2026/0119371 A1
(43) Pub. Date: Apr. 30, 2026

(54) ARTIFICIAL INTELLIGENCE-BASED LOG INFORMATION INCORPORATION INTO CODE

(71) Applicant: Dell Products L.P., Round Rock, TX (US)

(72) Inventors: Kiran Rangavajulla, Bangalore (IN); Abhishek Mishra, Bangalore (IN); Vivek Bhargava, Bangalore (IN); Vaideeswaran Ganesan, Bangalore (IN)

(21) Appl. No.: 18/930,321

(22) Filed: Oct. 29, 2024

(51) Int. Cl. G06F 11/36; G06F 11/34

(52) U.S. Cl. CPC G06F 11/3624; G06F 11/3476

(57) ABSTRACT

Methods, apparatus, and processor-readable storage media for artificial intelligence-based log information incorporation into code are provided herein. An example computer-implemented method includes processing, using at least one API, source code associated with at least one web-based application; identifying a first set of one or more variables within one or more portions of the source code by processing the portion(s) of the source code in conjunction with code-related data structures comprising code-related storage information; identifying a second set of one or more variables within the portion(s) of the source code by processing the portion(s) of the source code using one or more artificial intelligence techniques trained on variable naming data; and incorporating, at one or more positions within the source code, log information pertaining to one or more of at least a portion of the first set of variables and at least a portion of the second set of variables.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Logs can serve as useful information to help debug issues in all types of code-related environments (e.g., production environments). However, conventional code development approaches often include insufficient and/or inaccurate logging, which results in additional cycles spent in interactions with users, sending the users instrumented code with additional debug logs, reproducing portions of the code in the user environment, and retrieving the code therefrom. Such approaches thus often increase the time to repair various code-related issues, and result in time-intensive and resource-intensive code development cycles.

### SUMMARY

Illustrative embodiments of the disclosure provide techniques for artificial intelligence-based log information incorporation into code.

An exemplary computer-implemented method includes processing, using at least one application programming interface, source code associated with at least one web-based application, and identifying a first set of one or more variables within one or more portions of the source code by processing the one or more portions of the source code in conjunction with one or more code-related data structures comprising code-related storage information. The method also includes identifying a second set of one or more variables within the one or more portions of the source code by processing the one or more portions of the source code using one or more artificial intelligence techniques trained on variable naming data. Additionally, the method includes incorporating, at one or more positions within the source code, log information pertaining to one or more of at least a portion of the first set of one or more variables and at least a portion of the second set of one or more variables.

Illustrative embodiments can provide significant advantages relative to conventional code development approaches. For example, problems associated with time-intensive and resource-intensive code development cycles arising from insufficient and/or inaccurate logging are overcome in one or more embodiments through artificial intelligence-based identification of source code variables for use in automatically incorporating related log information.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for artificial intelligence-based log information incorporation into code in an illustrative embodiment.

FIG. 2 shows example architecture for an automated artificial intelligence-based log incorporation system in an illustrative embodiment.

FIG. 3 shows example pseudocode for implementing at least a portion of a controller function in an illustrative embodiment.

FIG. 4 shows example pseudocode for a post log injection of a source in an illustrative embodiment.

FIG. 5 is a flow diagram of a process for artificial intelligence-based log information incorporation into code in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

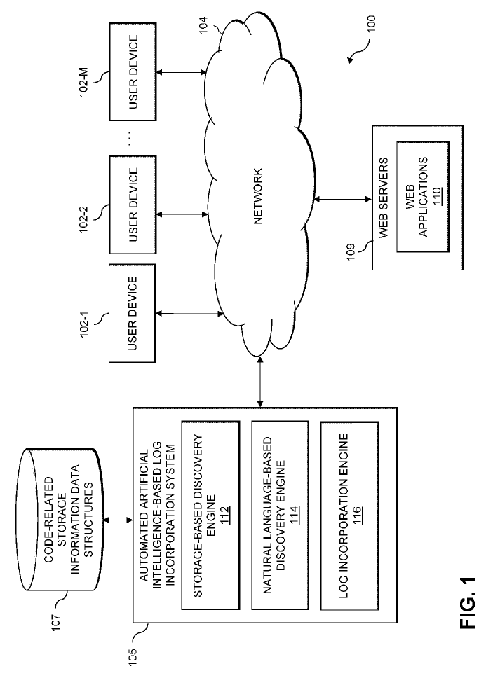

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated artificial intelligence-based log incorporation system 105 and one or more web applications 110 running on one or more web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated artificial intelligence-based log incorporation system 105 can have one or more code-related storage information data structures 107 configured to store data pertaining to identifiers and primary keys pertaining to one or more code-related database schemas, source code keys, key constraints, source code statement variables, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The code-related storage information data structures 107 in the present embodiment are implemented using one or more storage systems associated with the automated artificial intelligence-based log incorporation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated artificial intelligence-based log incorporation system 105 are one or more input-output devices, which illustratively comprise keyboards, displays or other types of input-output devices in any combination. Such input-output devices can be used, for example, to support one or more user interfaces to the automated artificial intelligence-based log incorporation system 105, as well as to support communication between the automated artificial intelligence-based log incorporation system 105 and other related systems and devices not explicitly shown.

Additionally, the automated artificial intelligence-based log incorporation system 105 in the FIG. 1 embodiment is assumed to be implemented using at least one processing device. Each such processing device generally comprises at least one processor and an associated memory, and implements one or more functional modules for controlling certain features of the automated artificial intelligence-based log incorporation system 105.

More particularly, the automated artificial intelligence-based log incorporation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated artificial intelligence-based log incorporation system 105 to communicate over the network 104 with the user devices 102, and illustratively comprises one or more conventional transceivers.

The automated artificial intelligence-based log incorporation system 105 further comprises storage-based discovery engine 112, natural language-based discovery engine 114, and log incorporation engine 116. In one or more embodiments, the storage-based discovery engine 112 processes source code to identify one or more elements stored in data storage and used as unique identifiers and/or primary keys in a database schema. Also, the natural language-based discovery engine 114 processes source code, using variable names with one or more given prefixes, to identify one or more key variables in the source code. Further, in at least one embodiment, the log incorporation engine 116 incorporates and/or injects one or more log statements into one or more particular portions of source code by logging one or more designated parameters and/or return variables.

It is to be appreciated that this particular arrangement of elements 112, 114 and 116 illustrated in the automated artificial intelligence-based log incorporation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for artificial intelligence-based log information incorporation into code involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated artificial intelligence-based log incorporation system 105, code-related storage information data structures 107, and web servers 109 can be on and/or part of the same processing platform.

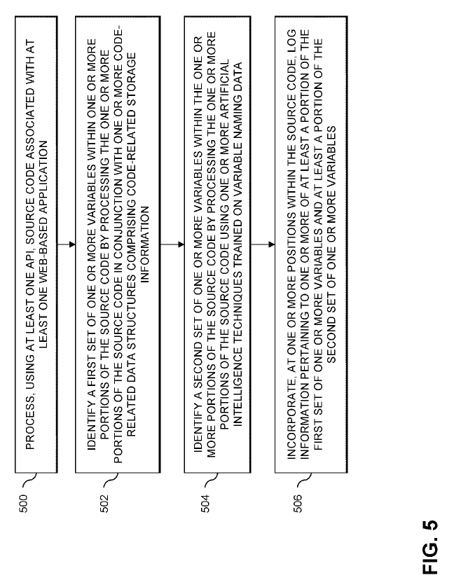

An exemplary process utilizing elements 112, 114 and 116 of an example automated artificial intelligence-based log incorporation system 105 in computer network 100 will be described in more detail with reference to the flow diagram of FIG. 5.

Accordingly, at least one embodiment includes implementing techniques for automated artificial intelligence-based log ingestion using static code analysis for enhanced debuggability. In many contexts, if too much logging is carried out, it will lead to performance degradation, whereas if insufficient logging is carried out, extended time may need to be expend in debugging. Also, different contexts can present different semantic meanings associated with one or more code development variables, providing further challenge to logging processes. Accordingly, one or more embodiments include tagging and/or annotating one or more code development variables (e.g., input/output variables, key variables, etc.) based at least in part on the level and/or the type of influence imparted on the code by the given variable, and using those annotations to generate and/or output certain logs determined and/or predicted to be useful for one or more debugging operations. As used herein, logs broadly refer to digital information (e.g., records, traces, etc.) pertaining to events occurring in connection with one or more devices, one or more systems, one or more networks, etc.

As further detailed herein, at least one embodiment includes enhancing the quality of logging, and leveraging such log information to more efficiently determine and/or identify code-related issues. In such an embodiment, an automated system is configured to inject log statements into code. More particularly, the automated system examines the code, identifies one or more variables in the code to be logged, and ensures that every branch of the code is represented and the appropriate type(s) of information is incorporated into the log information (e.g., information which can be used for future code debugging).

One or more embodiments can include implementing the techniques detailed herein within services and microservices environments, wherein such environments have well-defined end points. Additionally, programming languages (e.g., C#, Java, Python, etc.) often provide programmatic application programming interfaces (APIs) to parse a program written in that language, and at least one embodiment can include utilizing such APIs to examine a parse tree of the given program (i.e., the code of the given program). Such an embodiment can include using such APIs to load the code and examine the parse tree to identify one or more patterns that can improve and/or enhance logging.

Also, web services development can include using various data manipulation patterns (e.g., ActiveX Data Objects (ADO) and/or Java Data Objects (JDO) patterns), which can be mapped to JavaScript object notation (JSON) and/or extensible markup language (XML) using one or more serialization techniques. Additionally, programming languages commonly support decorators, annotations, and/or class attributes to provide information and/or hints to compilers regarding the objective(s) of a given method. At least one embodiment can include using such information to determine whether a method is an end point, whether a class is a JDO and/or ADO or represents an object representing a JSON and/or database schema object, etc. Further, programming languages also often contain support for infrastructure services such as, e.g., web services, data storage connectivity, etc., and one or more embodiments include leverage such infrastructure services support.

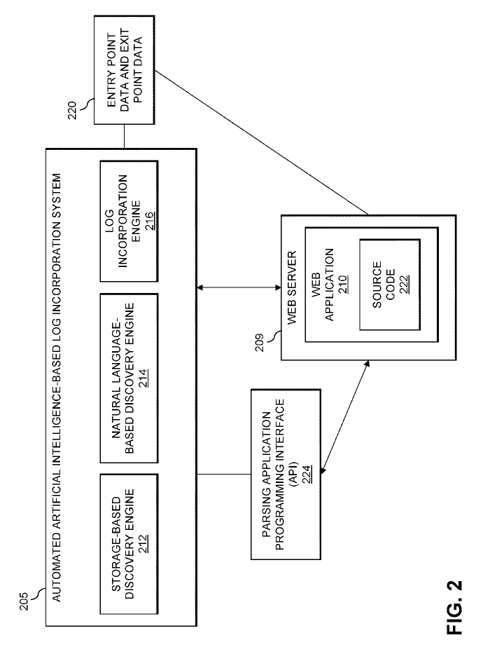

FIG. 2 shows example architecture for an automated artificial intelligence-based log incorporation system in an illustrative embodiment. By way of illustration, FIG. 2 depicts automated artificial intelligence-based log incorporation system 205, which performs a discovery phase and a code incorporation (also referred to herein as code injection) phase in connection with source code 222 derived from one or more web applications 210 (running and/or being developed on web servers 209). In the discovery phase, source code 222 is parsed, one or more entry points (derived from entry point data and exit point data 220) are processed, and the source code 222 is traversed from the one or more entry points onwards. During the discovery phase, one or more embodiments can include tracing input variables and annotating and/or tagging the variables in all functions in accordance with one or more designated tags.

More particularly, the discovery phase can include storage-based discovery carried out by storage-based discovery engine 212, which can leverage a property that one or more elements of source code are typically stored in data storage and are typically used as unique identifiers and/or primary keys in a database schema. In determining and/or identifying such keys, and as further detailed herein, storage-based discovery engine 212 can trace variables in one or more statements of source code 222 for those types of values and/or search for one or more fields in source code 222 with unique key constraints and which do not have a fixed set of values.

Also, the discovery phase can include natural language-based discovery carried out by natural language-based discovery engine 214, which can leverage the use of variable names with one or more given prefixes for identifying one or more key variables in the source code 222.

As also depicted in FIG. 2, in connection with the discovery phase, log incorporation engine 216 performs a code incorporation or code injection phase. The code incorporation or code injection phase can include searching for entry point data and exit point data 220 in the source code 222. Entry points are represented by the entering of one or more given functions, and exit points are represented by return and/or finally statements, throw statements without corresponding catches, throw statements with corresponding catches with re-throws, and/or such statements that semantically transfer control out of the given function. At entry points and/or exit points, log incorporation engine 216 incorporates and/or injects one or more log statements by logging one or more designated parameters and return variables.

More particularly, in the code incorporation phase, log information is incorporated and/or injected into the source code 222 using log incorporation engine 216 in one or more places wherein the log entries are incomplete or do not exist. The injected code can then be built, and one or more tests can be run to ensure there are no regressions.

Referring again to the discovery phase, one or more embodiments can include loading the source code 222 through parsing API 224. From the parsing API 224, such an embodiment includes extracting one or more functions which are indicative of an end point by examining one or more relevant attributes (e.g., HttpPost, HttpGet, @WebServlet, @HttpConstraint, etc.) and/or by determining whether one or more non-constructor functions belong to a class that is derived from one or more relevant infrastructure classes. Such determinations can be carried out, for example, using one or more service methods which define the type of operation being performed, wherein such information can then be leveraged to derive the class information. The inputs to such functions can include, for example, ADO and/or JDO objects which represent the input from a stream in form of JSON and/or XML, and the outputs to such functions can include, e.g., other ADO and/or JDO objects which represent the output to the stream. In such an embodiment, traces include descriptions of how the inputs are converted and/or processed into output(s).

Further, for each such function, at least one embodiment includes tracing the code flow, observing statements and tagging variables within the statements as “Influence,” “Important” and/or “Key.” When a function is reached, such an embodiment includes entering that function, recursively forming the same pattern. For example, if the necessary information is not obtained, such an embodiment can include going through a cycle of tagging variables as “Influence,” “Important,” and/or “Key” until the information is discovered.

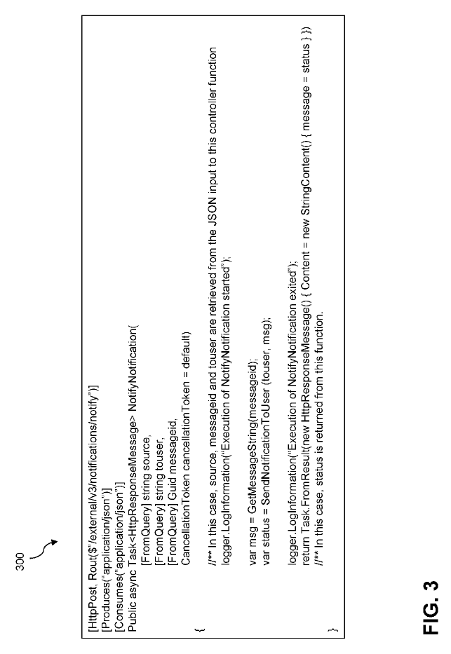

FIG. 3 shows example pseudocode for implementing at least a portion of a controller function in an illustrative embodiment. In this embodiment, example pseudocode 300 is executed by or under the control of at least one processing system and/or device. For example, the example pseudocode 300 may be viewed as comprising a portion of a software implementation of at least part of automated artificial intelligence-based log incorporation system 105 of the FIG. 1 embodiment.

The example pseudocode 300 illustrates an example endpoint of /external/v3/notifications/notify being called, which is defined inside a classed NotificationController. Accordingly, as depicted in example pseudocode 300, source, to user and messageid are the input variables, whereas status is the variable that is returned from the controller function.

It is to be appreciated that this particular example pseudocode shows just one example implementation of at least a portion of a controller function, and alternative implementations can be used in other embodiments.

When an assignment statement (e.g., an assignment statement that results in the changing of a value) contains a given variable from the input of a statement, one or more embodiments including tagging and/or annotating that variable as input-direct-influence. Such an embodiment also includes retrieving all other input variables from the statement and associating the other input variables with the given variable (e.g., associating the other input variables as direct influencers). When there is a condition (e.g., if, switch, while, until, etc.) present in the code, and input variables are used in the condition, at least one embodiment include retrieving those input variables from the condition and associating those input variables with the given variable (e.g., associating those input variables as indirect-input-influencers).

Additionally, at least one embodiment includes treat “Influence” variables as “input variables” and applying the above-noted steps multiple times until there are no more “Influence” variables to apply. Subsequently, such an embodiment includes performing a reverse trace, beginning from the output and/or return responses in the endpoint functions. In the reverse trace, such an embodiment includes processing the assignment statements with output variables on the left-hand side (LHS) of the equation, and tagging and/or annotating variables which are on the right-hand side (RHS) of the equation as “Influence” with “output-direct-influence” fields. More particularly, in such an embodiment, the RHS provides the value to be stored, and the LHS contains the name of the variable (referred to as such because its contents can change throughout a program) that will store that value. Such an embodiment can also include similarly identifying “output-indirect-influencers” among variables found in conditions within conditional statements. Also, with respect to functional calls, one or more embodiments include processing the output parameters and response(s) as candidates for computing output influencers.

Additionally, at least one embodiment includes identifying and/or processing only those variables which have at least one influencer, determining how those variables are used in any statement other than an assignment, and tagging and/or annotating at least a portion of these variables as “Important” variables. More particularly, such an embodiment can include tagging, as “Important,” the variables which are making direct or indirect influence on the output.

By way of illustration, in the example depicted in FIG. 3, the variable status is an assignment statement that makes a function call which takes in one of the input variables (namely, the ToUser variable). In this function, the message is ignored, and as such, ToUser is an indirect input influencer for the variable status. Accordingly, this same variable status is returned from the function, and hence, the variable status variable becomes an indirect output influencer. Because the variable status is used in return statements (other than just an assignment), and the variable status also has indirect input and output influencers, this variable status becomes an “Important”variable. As used herein, variable status indicates that the instance value can change during execution, whereas status refers to a successful or unsuccessful operation code or message, and an input variable refers to the instance value being passed in the transaction.

Similarly, referring again to the example depicted in FIG. 3, the variable message (msg) has one indirect input influencer (that is, messageid) and one indirect output influencer (which influences the status variable, which in turn influences the output), and is used in a SendNotificationToUser function call. Accordingly, the variable message is also deemed an “Important” variable.

As part of the at least one discovery phase, and as detailed herein, one or more embodiments include identifying key fields by way of storage-based discovery and natural language-based discovery. With respect to storage-based discovery, such an embodiment includes leveraging the property that one or more keys are typically stored in data storage and are typically used as unique identifiers and/or primary keys in a database schema. Also, in one or more embodiments, key variables can include variable instances in the given payload which are used to identify the primary keys database context. For example, LOG_ID can be the primary key for relation transaction logs.

In determining and/or identifying such keys, one or more embodiments include tracing variables in one or more structured query language (SQL) statements for those types of values. For example, assume that a statement includes “Insert into table (field1, field2, field3) values (@v1, @v2, @v3),” and the table schema associates field2 as a primary key constraint. In such a context, at least one embodiment can include inferring that field2 is the key, and the value passed to field2 is the key field.

Additionally or alternatively, one or more embodiments can include using auto-numbering keys, wherein the key field is not specified, but is a unique identifier (ID) generated automatically by a SQL database. In that context, such an embodiment includes searching for one or more fields with unique key constraints and which do not have a fixed set of values. The variables that are associated with those key fields are tagged and/or annotated as “keys.”

With respect to natural language-based discovery, at least one embodiment can include leveraging the use of variable names with prefixes such as, for example, “id,” “key,” or “token,” for identifying one or more key variables, as well as leveraging the use of a “name” prefix (e.g., username, systemname, authkeyname, etc.) to identify at least one name attribute (which can include a unique value). As part of natural language-based discovery, one or more embodiments include ensuring that only those variables which have previously been identified as “Influence” are tagged and/or annotated as “keys,” as there can be many IDs used in connection with the code development, and such IDs are not necessarily always influencing the input/output and/or storage.

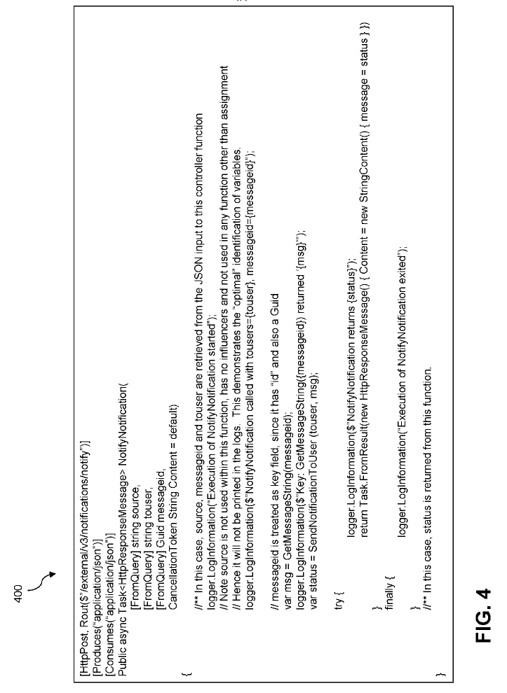

Subsequent to the at least one discovery phase, one or more embodiments include implementing at least one code incorporation or code injection phase. In the examples detailed in connection with FIG. 3 and FIG. 4, the word messageid ends with “id” (and is a globally unique identifier (GUID)), indicating that messageid is a key of some type. Accordingly, the log message can be incorporated or injected in the code after the call to GetMessageString() to print the string returned after converting this ID to string.

Additionally, in connection with the at least one code incorporation or code injection phase, one or more embodiments include searching for one or more entry points and one or more exit points. Entry points are represented by the entering of one or more given functions, and exit points are represented by return and/or finally statements, throw statements without corresponding catches, throw statements with corresponding catches with re-throws, and/or such statements that semantically transfer control out of the given function. At entry points and/or exit points, one or more embodiments can include incorporating and/or injecting log statements by logging one or more “important” parameters and return variables. As used herein and also further detailed herein, a parameter defines the behavior of an output while a variable is used to store information and can vary in different scenarios.

Also, as part of a code incorporation or code injection phase, at least one embodiment can include searching for infrastructure statements (e.g., database calls, remote web service calls, etc.). For example, ExecuteNonQuery statements are statements which create, modify and/or delete entries in a database, and web calls which use modifying operations (e.g., POST, PATCH, PUT, DELETE, etc.) are used to modify the resources. Such an embodiment can include processing the variables passed to such statements and introducing logs (if not present) based at least in part on the type of operation and the key field that is being used. At least one embodiment can also include incorporating one or more important variables during these operations.

Further, as part of a code incorporation or code injection phase, one or more embodiments include processing branch statements (e.g., if and switch) and, when any important variable is modified, incorporating and/or inserting a log statement after all changes are made to important variables and before another branch or the end of that branch statement.

FIG. 4 shows example pseudocode for a post log injection of a source in an illustrative embodiment. In this embodiment, example pseudocode 400 is executed by or under the control of at least one processing system and/or device. For example, the example pseudocode 400 may be viewed as comprising a portion of a software implementation of at least part of automated artificial intelligence-based log incorporation system 105 of the FIG. 1 embodiment.

The example pseudocode 400 illustrates retrieving source, messageid and touser from the JSON input to this controller function. Additionally, it is noted that source is not used within this function, has no influencers, and is not used in any function other than the assignment function. Accordingly, source will not be printed in the logs. Also, example pseudocode 400 illustrates the optimal identification of variables, wherein, for example, messageid is treated as a key field because messageid has “id” and also a GUID. Further, as seen in example pseudocode 400, status is returned from this controller function.

It is to be appreciated that this particular example pseudocode shows just one example implementation of a post log injection of a source, and alternative implementations can be used in other embodiments.

As detailed herein, one or more embodiments include identifying code-related variables that are directly and/or indirectly influenced by input/output to at least one endpoint, and identifying one or more variables (e.g., the optimal variables) in the code for logging based at least in part on the impact of the variables in connection with decision making. Such an embodiment also includes incorporating or inserting the corresponding logs at one or more relevant points based at least in part on one or more decision making points (e.g., branches, control transfer points, etc.) in the code as well as results of static code analysis. Such incorporated or inserted logs can include selected information (e.g., only the important and key variables) to enhance quality and efficiency of one or more future debugging operations.

Further, the techniques detailed herein can enable enhanced integration with log monitoring and/or analysis tools, which in turn can enable enhance discovery of actionable insights with reduced needs for filling log gaps. Additionally, implementation of the techniques detailed herein can also reduce turnaround time and resource requirements for troubleshooting and/or code debugging, as an increase of relevant information will be incorporated in the logs.

FIG. 5 is a flow diagram of a process for artificial intelligence-based log information incorporation into code in an illustrative embodiment. It is to be understood that this particular process is only an example, and additional or alternative processes can be carried out in other embodiments.

In this embodiment, the process includes steps 500 through 506. These steps are assumed to be performed by the automated artificial intelligence-based log incorporation system 105 utilizing elements 112, 114 and 116.

Step 500 includes processing, using at least one API, source code associated with at least one web-based application. In at least one embodiment, processing the source code associated with at least one web-based application includes traversing, using the at least one API, the source code from at least one identified entry point within the source code, and tagging one or more input variables and one or more variables in one or more functions within the source code.

Step 502 includes identifying a first set of one or more variables within one or more portions of the source code by processing the one or more portions of the source code in conjunction with one or more code-related data structures comprising code-related storage information. In one or more embodiments, identifying the first set of one or more variables includes identifying one or more variables pertaining to one or more identifiers in at least one database schema associated with the source code. Further, in one or more embodiments, identifying the first set of one or more variables can be carried out using one or more artificial intelligence techniques. Additionally or alternatively, identifying the first set of one or more variables can include identifying one or more variables pertaining to one or more fields with one or more unique key constraints and which lack a fixed set of values.

Step 504 includes identifying a second set of one or more variables within the one or more portions of the source code by processing the one or more portions of the source code using one or more artificial intelligence techniques trained on variable naming data. In at least one embodiment, processing the one or more portions of the source code using one or more artificial intelligence techniques trained on variable naming data includes processing the one or more portions of the source code using one or more artificial intelligence techniques trained on variable prefix data and variable suffix data. Also, the first set of one or more variables and the second set of one or more variables can share at least one variable. Alternatively, the first set of one or more variables can be distinct from the second set of one or more variables.

Additionally, in at least one embodiment, identifying the second set of one or more variables includes processing the one or more portions of the source code using one or more natural language processing techniques (e.g., bidirectional encoder representations from transformers (BERT), generative pre-trained transformers (GPTs), etc.) trained on variable naming data.

Step 506 includes incorporating, at one or more positions within the source code, log information pertaining to one or more of at least a portion of the first set of one or more variables and at least a portion of the second set of one or more variables. In one or more embodiments, incorporating log information at one or more positions within the source code includes incorporating the log information at one or more of at least one branch statement within the source code, at least one infrastructure statement within the source code, and at least one control transfer point within the source code. Additionally or alternatively, incorporating log information at one or more positions within the source code can include incorporating the log information at one or more of at least one position within the source code which contains incomplete log information and at least one position within the source code wherein log information is expected but not present. Also, incorporating log information at one or more positions within the source code can include incorporating the log information in connection with identifying one or more entry and one or more exit points within the source code.

In at least one embodiment, the techniques depicted in FIG. 5 can also include automatically testing at least a portion of the source code subsequent to incorporating the log information. Further, the techniques depicted in FIG. 5 can additionally include automatically training at least a portion of the one or more artificial intelligence techniques based at least in part on feedback related to the incorporating of the log information at the one or more positions within the source code.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to dynamically identify source code variables for use in automatically incorporating related log information. These and other embodiments can effectively overcome problems associated with time-intensive and resource-intensive code development cycles arising from insufficient and/or inaccurate logging.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

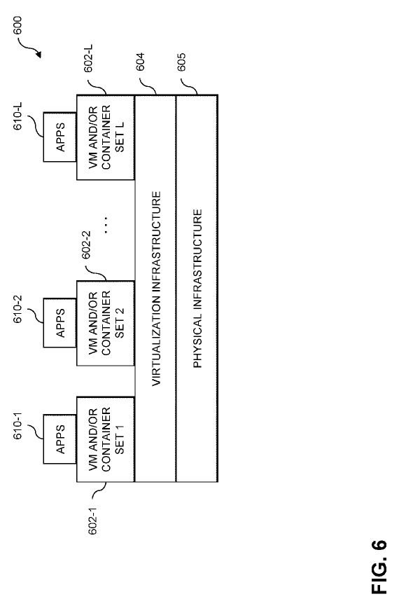

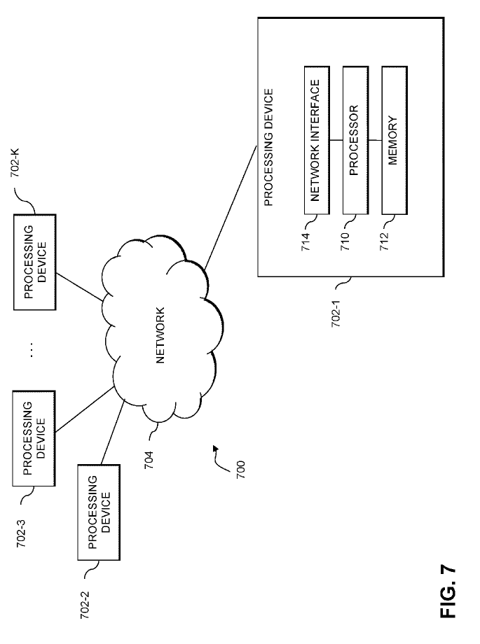

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing, using at least one application programming interface, source code associated with at least one web-based application;
identifying a first set of one or more variables within one or more portions of the source code by processing the one or more portions of the source code in conjunction with one or more code-related data structures comprising code-related storage information;
identifying a second set of one or more variables within the one or more portions of the source code by processing the one or more portions of the source code using one or more artificial intelligence techniques trained on variable naming data; and
incorporating, at one or more positions within the source code, log information pertaining to one or more of at least a portion of the first set of one or more variables and at least a portion of the second set of one or more variables;
wherein the method is performed by at least one processing device comprising a processor coupled to a memory.

2. The computer-implemented method of claim 1, wherein identifying the first set of one or more variables comprises identifying one or more variables pertaining to one or more identifiers in at least one database schema associated with the source code.

3. The computer-implemented method of claim 1, wherein processing the one or more portions of the source code using one or more artificial intelligence techniques trained on variable naming data comprises processing the one or more portions of the source code using one or more artificial intelligence techniques trained on variable prefix data and variable suffix data.

4. The computer-implemented method of claim 1, wherein incorporating log information at one or more positions within the source code comprises incorporating the log information at one or more of at least one branch statement within the source code, at least one infrastructure statement within the source code, and at least one control transfer point within the source code.

5. The computer-implemented method of claim 1, wherein processing the source code associated with at least one web-based application comprises traversing, using the at least one application programming interface, the source code from at least one identified entry point within the source code, and tagging one or more input variables and one or more variables in one or more functions within the source code.

6. The computer-implemented method of claim 1, wherein identifying the first set of one or more variables comprises identifying one or more variables pertaining to one or more fields with one or more unique key constraints and which lack a fixed set of values.

7. The computer-implemented method of claim 1, wherein the first set of one or more variables and the second set of one or more variables share at least one variable.

8. The computer-implemented method of claim 1, wherein the first set of one or more variables is distinct from the second set of one or more variables.

9. The computer-implemented method of claim 1, wherein identifying the second set of one or more variables comprises processing the one or more portions of the source code using one or more natural language processing techniques trained on variable naming data.

10. The computer-implemented method of claim 1, wherein incorporating log information at one or more positions within the source code comprises incorporating the log information at one or more of at least one position within the source code which contains incomplete log information and at least one position within the source code wherein log information is expected but not present.

11. The computer-implemented method of claim 1, wherein incorporating log information at one or more positions within the source code comprises incorporating the log information in connection with identifying one or more entry and one or more exit points within the source code.

12. The computer-implemented method of claim 1, further comprising:
automatically testing at least a portion of the source code subsequent to incorporating the log information.

13. The computer-implemented method of claim 1, further comprising:
automatically training at least a portion of the one or more artificial intelligence techniques based at least in part on feedback related to the incorporating of the log information at the one or more positions within the source code.

14. A non-transitory processor-readable storage medium having stored therein program code of one or more software programs, wherein the program code when executed by at least one processing device causes the at least one processing device:
to process, using at least one application programming interface, source code associated with at least one web-based application;
to identify a first set of one or more variables within one or more portions of the source code by processing the one or more portions of the source code in conjunction with one or more code-related data structures comprising code-related storage information;
to identify a second set of one or more variables within the one or more portions of the source code by processing the one or more portions of the source code using one or more artificial intelligence techniques trained on variable naming data; and
to incorporate, at one or more positions within the source code, log information pertaining to one or more of at least a portion of the first set of one or more variables and at least a portion of the second set of one or more variables.

15. The non-transitory processor-readable storage medium of claim 14, wherein identifying the first set of one or more variables comprises identifying one or more variables pertaining to one or more identifiers in at least one database schema associated with the source code.

16. The non-transitory processor-readable storage medium of claim 14, wherein processing the one or more portions of the source code using one or more artificial intelligence techniques trained on variable naming data comprises processing the one or more portions of the source code using one or more artificial intelligence techniques trained on variable prefix data and variable suffix data.

17. The non-transitory processor-readable storage medium of claim 14, wherein incorporating log information at one or more positions within the source code comprises incorporating the log information at one or more of at least one branch statement within the source code, at least one infrastructure statement within the source code, and at least one control transfer point within the source code.

18. An apparatus comprising:
at least one processing device comprising a processor coupled to a memory;
the at least one processing device being configured:
to process, using at least one application programming interface, source code associated with at least one web-based application;
to identify a first set of one or more variables within one or more portions of the source code by processing the one or more portions of the source code in conjunction with one or more code-related data structures comprising code-related storage information;
to identify a second set of one or more variables within the one or more portions of the source code by processing the one or more portions of the source code using one or more artificial intelligence techniques trained on variable naming data; and
to incorporate, at one or more positions within the source code, log information pertaining to one or more of at least a portion of the first set of one or more variables and at least a portion of the second set of one or more variables.

19. The apparatus of claim 18, wherein identifying the first set of one or more variables comprises identifying one or more variables pertaining to one or more identifiers in at least one database schema associated with the source code.

20. The apparatus of claim 18, wherein processing the one or more portions of the source code using one or more artificial intelligence techniques trained on variable naming data comprises processing the one or more portions of the source code using one or more artificial intelligence techniques trained on variable prefix data and variable suffix data.
